(19) United States
(12) Patent Application Publication
(10) Pub. No.: US 2004/0165764 A1
(43) Pub. Date: Aug. 26, 2004

(54) Method and apparatus for examining semiconductor wafers in a context of die/SAW design

(75) Inventor: Detlef Michelsson, Wetzlar-Naunheim (DE)

Correspondence Address: HOUSTON ELISEEVA, 4 MILITIA DRIVE, SUITE 4, LEXINGTON, MA, 02421, US

(73) Assignee: Leica Microsystems Semiconductor GmbH, Wetzlar (DE)

(21) Appl. No.: 10/772,510

(22) Filed: Feb. 5, 2004

(30) Foreign Application Priority Data
Feb. 21, 2003 (DE) DE10307373.6

(51) Int. Cl. G06K 9/00

(52) U.S. Cl. 382/147

(57) ABSTRACT

The invention takes into account the fact that the size of the SAWs varies greatly depending on the stepper and the die size (design). In general, it cannot be assumed that one SAW can be imaged with one camera image. A SAW is preferably broken down into regular logical parts (segments) of identical size. A SAW index is allocated to each logical SAW segment. One image field of the camera can image only a certain number of these SAW segments. An index, hereinafter called an image field segment index, is allocated to each segment of an image field, hereinafter called an image field segment.

### RELATED APPLICATIONS

This application claims priority of the German patent application 103 07 373.6 which is incorporated by reference herein.

### FIELD OF THE INVENTION

The invention concerns a method and an apparatus for optical analysis of wafers whose features were generated using SAWs.

### BACKGROUND OF THE INVENTION

A patterned semiconductor wafer comprises dice and the “roads” located between the dice. A specific number of dice are exposed at one time using a stepper. The region that is exposed with one shot or one image is called a “stepper area window” (SAW). Since all the SAWs on one semiconductor wafer are exposed using the same mask, all the features outside the dice are also at the same location in each SAW. In principle, it is conceivable for various dice to be accommodated in one SAW. The known procedure of comparing adjacent dice to one another is thus inadvisable.

### SUMMARY OF THE INVENTION

It is the object of the invention to make available an efficient method for the analysis of wafers that performs comparisons using optical images.

This object is achieved by a method comprising the steps of:

moving a camera, having an image flied, over a wafer and thereby acquiring with its image field a plurality of images;

initializing in a learning phase the image field of the camera, wherein the image field of the camera is divided into SAW-segment-imaging image field segments in such a way that after a definable interval of acquired images, a repetition of an identical allocation of imaged SAW segments in image field segments occurs; and

carrying out comparison operations in run phases, in which the image field segments of images that have an identical allocation of image field segments to imaged SAW segments are compared with one another and/or with a specific master.

It is an other object of the invention to make available an apparatus for the analysis of surface images of wafers, wherein the apparatus performs comparisons optical images in an efficient way.

The above object is achieved by an apparatus comprising:

a camera to acquire a plurality of images of the at least one wafer, wherein the camera defines an image field;

a memory region in which the plurality of images of the wafer, acquired with the camera, are storable;

means for initializing in a learning phase in which the image field of the camera is divided into SAW-segment-imaging image field segments in such a way that after a definable interval of acquired images, a repetition of an identical allocation of imaged SAW segments in image field segments occurs; and

a processing unit for carrying out comparison operations in such a way that in, the image field segments of images that have an identical allocation of image field segments to imaged SAW segments are compared with one another and/or with a specific model.

For an abstract description, the SAW will be considered below as a single repeating feature.

The invention takes into account the fact that the size of the SAWs varies greatly depending on the stepper and the die size (design). In general, it cannot be assumed that one SAW can be imaged with one camera image.

A SAW is therefore preferably broken down into regular logical parts (segments) of identical size. A SAW index is allocated to each logical SAW segment.

One image field of the camera can image only a certain number of these SAW segments. An index, hereinafter called an image field segment index, is allocated to each segment of an image field, hereinafter called an image field segment. The indices and their combination are described in detail in the Figures described below.

This approach is not limited to area cameras. If only one line is used for image acquisition, the logical SAW segments must then be broken down into a one-pixel width. All other algorithms for division into mutually comparable segments remain intact.

A further advantage of the invention is that all the information about the division into groups, the size of the image to be acquired, and the number and position of the images, needs to be determined only once in the learning phase. In the run phase all the steps are already defined, so that all the memory structures can be set up once and then merely continuously refilled. Fragmentation of the memory of the comparison unit is thus prevented.

The invention concerns, in detail, a method for optical analysis of a wafer which has features that were generated using a SAW. A camera, as it travels over the wafer, acquires with its image field a plurality of images that are stored digitally. The acquired images are preferably broken down into image field segments according to the method below.

In an initialization step, also called a learning step, the image field of the camera is divided, preferably by way of an interactive control system (PC monitor, keyboard, and mouse), into SAW-segment-imaging image field segments in such a way that after a definable interval of acquired images, a repetition of an identical allocation of imaged SAW segments to image field segments occurs. This interval should not be made too large. If a minimum interval is desired, a corresponding optimization can be performed automatically by the system. This is also conceivable at other spacings. Known optimization algorithms are conceivable, e.g. interval halving. This initialization phase is executed only once for a wafer type. After initialization has taken place and the image data are read in, all that remains is to perform the comparison operations, in which the image field segments of images that have an identical allocation of image field segments to imaged SAW segments are compared with one another.

The division of the SAWs into logical SAW segments is performed in such a way that the sizes of the respective SAW segments and image field segments are identical. It has proven to be advantageous for the SAW to be divided into preferably identically sized logical SAW segments.

A good solution for the comparison operations has proven to be a multi-dimensional data structure in which the logical SAW segments and the image field segments are each indexed, and the image field segments have allocated to them a combination of SAW segment index and image field segment index, on the basis of which a determination is made of the image field segments to be compared. In the comparison operations, those image field segments which have an identical combination of SAW segment index and image field segment index are compared with one another. A three-dimensional array or a corresponding hash function can be used as the data structure.

The best comparison results are obtained when physically adjacent image field segments are compared with one another. Since the camera often travels line-by-line or row-by-row over the wafer, in one possible embodiment the entire wafer is first imaged before the image field segments are compared with one another. In another possible embodiment, the comparison is begun as soon as the image field segments to be compared have been imaged. In both cases, the spacing in both dimensions can be taken into account. It is also possible, however, to use a model for the comparison, for example that of an optimum wafer whose image is stored in the memory.

SAWs are often offset in order to achieve optimum utilization of the wafer. This offset is also learned during the initialization step, and taken into account in determining the allocation.

Invalid regions of a SAW often occur, resulting e.g. from the edge location of the SAW. These regions within a SAW or SAW segment can be defined in the initialization phase. They are blanked out upon comparison of the image field segments.

It is self-evident that the initialization phase can be restarted repeatedly. This is important in particular if it is found that the division was not optimal or that incorrect comparisons were made. Changes can be accounted for even in edge regions that do not need to be taken into consideration.

A variety of systems can be used as cameras. On the one hand, both area cameras and line cameras, which take microscopic or macroscopic images, can be used. The resolution of the camera is generally matched to the imaging optical system, e.g. to the objective of a microscope or macroscope. For macroscopic images the resolution is, for example, 50 μm per pixel.

As a rule, the wafer is moved beneath the camera. It is also conceivable, however, for the camera to be moved relative to the wafer. This motion is continuous. The individual images are created by the fact that a diaphragm is opened and a corresponding flash is triggered. The flash is triggered as a function of the relative position of the wafer, which is communicated by way of corresponding position parameters of the stage that moves the wafer.

When a line camera is used, the wafer is preferably illuminated with a continuous light source. The relative motion between camera and wafer is once again continuous. Acquisition of the image is triggered either in position-dependent fashion by way of the relative position of the wafer and camera, or in terms of time by way of an electronic trigger circuit, or via software.

Further constituents of the invention are apparatuses that implement the method as defined in the method claims.

This refers preferably to a computer having a memory region and a processing unit that compares the data stored in the memory region with one another.

The two essential components are the initialization unit, which permits the data necessary in the learning phase to be communicated to the system; and the comparison unit, which preferably is a known processor and performs the comparison process after the image data have been read into the memory.

The initialization means are designed so that the image field of the camera is divided into SAW-segment-imaging image field segments in such a way that after a definable interval of acquired images, a repetition of an identical allocation of imaged SAW segments in image field segments occurs. These means are preferably a memory region having configuration parameters that have been transmitted to the system. In another embodiment it is also conceivable for a simulation to be performed. The configuration parameters can then be determined using the information defined by the simulation. It is likewise advantageous if the SAW size is communicated and the corresponding dice are labeled, so that the program, knowing the size of the camera's image field, can determine how the segmentation must look. These are simple optimization tasks that can be performed using known algorithms. The result of this simulation or calculation is then transmitted, in the initialization step, to the apparatus according to the present invention, which then performs corresponding divisions of the acquired images and stores them in corresponding memory regions. Arrays having multiple dimensions, or hash functions that allow multiple dimensions, can be used for memory management. It is thus conceivable for the hash functions to accept the image index and segmentation index as parameters, so that all the elements present in the hash chain can thus be compared with one another. A memory pool in which segments of identical size are stored makes memory management very simple. An allocation can thus always be made, and access is extremely easy.

It is also conceivable, however, for this division to be achieved interactively by the use of known pointing and display means (keyboard, monitor, mouse).

As has already been described above, preferably only those elements having matching indices, which on the basis of a metric are physically adjacent image field segments, are compared. Color deviations extending over the entire wafer can thereby be taken into consideration.

The offsets are likewise taken into account by storing parameters in the memory region. These deviations can be determined both at an optical input device and by way of a corresponding configuration language, which is then converted and transmitted to the apparatus. The apparatus then stores this information in a corresponding memory region.

A further constituent of the present invention is a software program which equips a conventional computer in such a way that the method as defined in the previously described Claims is executed.

### BRIEF DESCRIPTION OF THE DRAWINGS

The invention will be explained in more detail below with reference to exemplary embodiments that are depicted schematically in the Figures. Identical reference numbers in the individual Figures designate identical elements. In the individual Figures:

FIG. 1 shows a logically segmented SAW with corresponding index numbers;

FIG. 2 shows an image field of a camera with index letters of imageable logical SAW segments;

FIG. 3 shows an example of a combined index;

FIG. 4 is a flow chart of the initialization step; and

FIG. 5 shows an arrangement of wafer and camera.

### DETAILED DESCRIPTION OF THE INVENTION

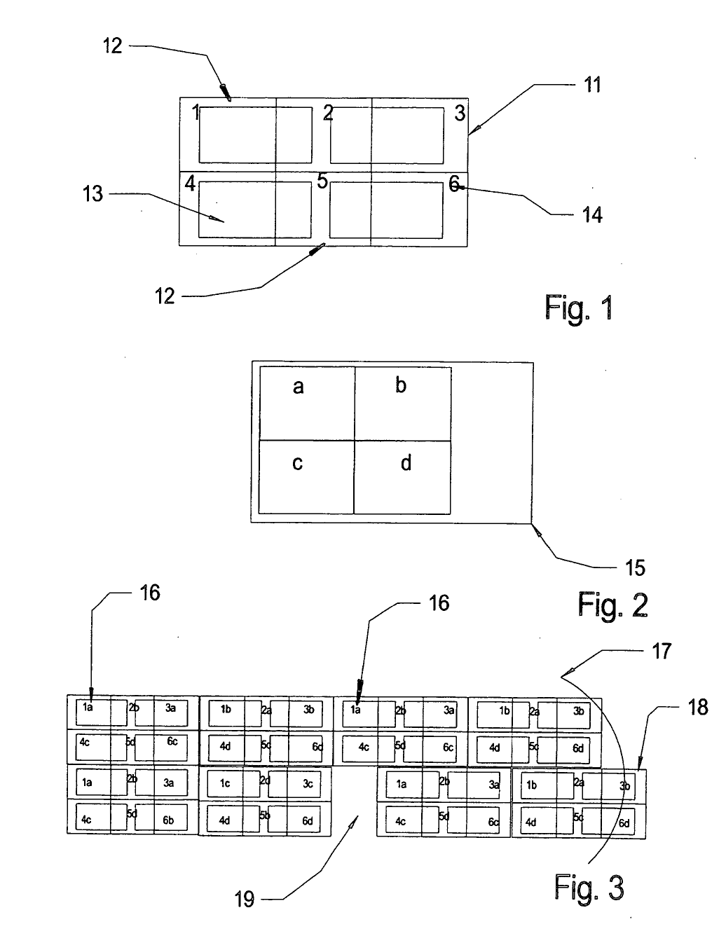

FIG. 1 shows a SAW 11 that is divided into segments 12. The SAW in turn contains several dice 13. The individual segments are labeled with a serial index 14. In the present case this index runs to the number 6.

FIG. 2 shows an image portion 15 that has four image field segments labeled with the letters a through d. These letters are also a corresponding index.

FIG. 3 shows a portion of a wafer having a wafer edge 17 and having an edge region 18 that is blanked out upon analysis. The wafer furthermore contains an offset 19.

When the two indices are combined, the first segment receives the index 1a. The first camera image encompasses image field segments 1a, 2b, 4c, 5d. The second camera image encompasses image field segments 3a, 1b, 6c, 4d, etc. The contents of the first and fourth images can be compared with one another, since they match in terms of both SAW index and image index.

It is of course possible both to compare the individual image field segments of the first image with the corresponding image field segments of the fourth image, and to compare groups of image field segments of the first image to those of the second, in a context of identical allocation.

When comparing the image field segments, however, care must be taken that the spacing between two segments having the same index does not become too great. If, for example, a SAW were divided into six logical segments in the X direction, but the image field of the camera images only five segments, the features will repeat only every six images (assuming complete filling). If an image field is filled with only four segments, however, the features repeat every three images.

A shift of the SAWs with respect to one another, as applied for better utilization of the wafer surface, can similarly be dealt with using this approach. With appropriate filling of the image field, there is in fact no need for separate groups for these shifted SAWs. A corresponding shift is visible in FIG. 3 at reference character 19.

Edge regions of wafers are often blanked out, as indicated by reference character 18. A corresponding setting in the initialization step is possible. The essential advantage lies in the one-time learning phase, which is then repeatedly taken into account during process execution while comparisons are being made.

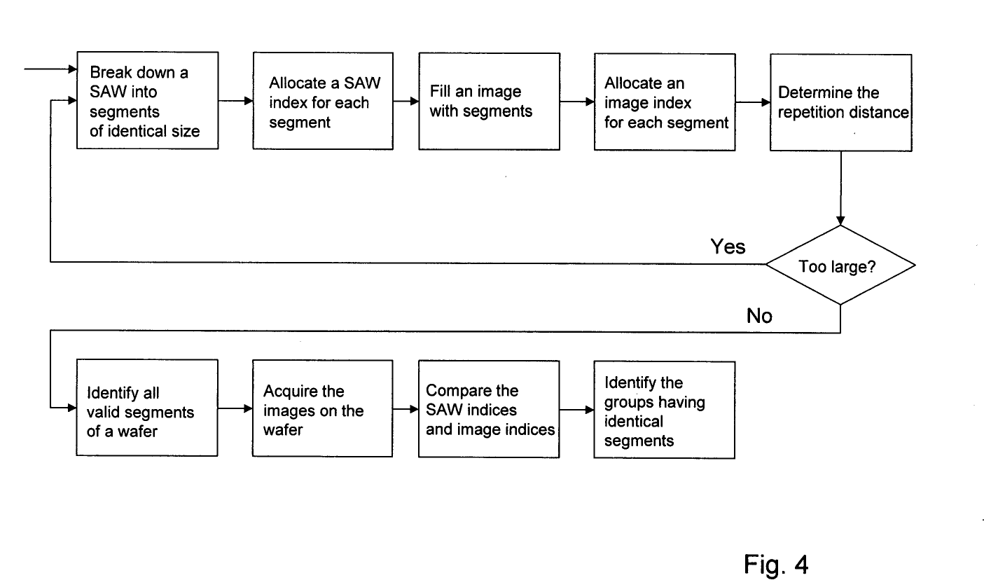

Execution of the initialization phase is illustrated in FIG. 4. Firstly the SAW is broken down into segments 12, and indices 14 are allocated. The image is then filled with image field segments a through d, and once again given indices 14. If the subsequent determination of repetition distances indicates values that are too great, the breakdown of the SAW into segments 12 must be performed again using different segment sizes. Once the distance is OK, all valid SAW segments 12 of the wafer are determined. This yields the list of valid images that are necessary for scanning the wafer. Lastly the SAW and image indices are compared, and on that basis groups having segments to be compared are created.

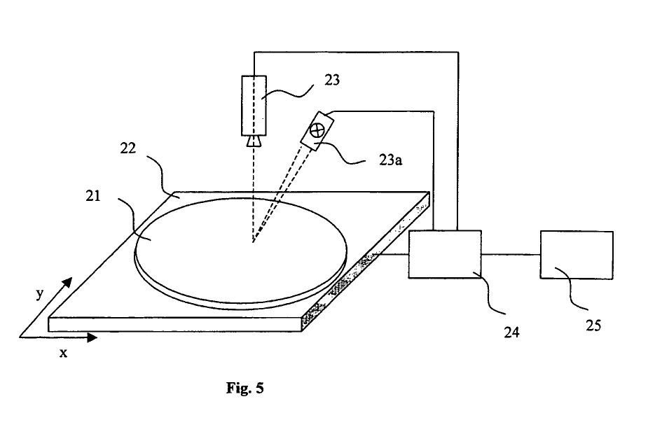

FIG. 5 schematically shows a wafer 21 which is located on a scanning stage 22 and of which a plurality of images are acquired by means of a camera 23. In this exemplary embodiment an X/Y scanning stage that can be displaced in the X and Y coordinate directions is used to generate a relative motion between scanning stage 22 and camera 23. Camera 23 is here installed immovably with respect to scanning stage 22. It is of course also possible, conversely, for scanning stage 22 to be installed immovably and for camera 22 to be moved over wafer 21 to acquire the images. Motion of camera 23 in one direction, and of scanning stage 22 in the direction perpendicular thereto, is also possible.

Wafer 21 is illuminated by an illumination device 23a that illuminates at least regions on wafer 21 which correspond to the image field of camera 23. The concentrated illumination, which moreover can also be pulsed using a flash lamp, makes possible acquisition of images on the fly, i.e. such that scanning stage 22 or camera 23 is displaced without stopping for image acquisition. This enables a rapid wafer throughput. It is of course also possible to stop the relative motion between scanning stage 22 and camera 23 for each image acquisition, and also to illuminate wafer 21 over its entire surface. Scanning stage 22, camera 23, and illumination device 23a are controlled by a control unit 24. The acquired images can be stored in a computer 25 and optionally also processed therein.

What is claimed is:

1. A method for analyzing at least one wafer which has a plurality features that were generated with a SAW, comprising the steps of:
moving a camera, having an image flied, over a wafer and thereby acquiring with its image field a plurality of images;
initializing in a learning phase the image field of the camera, wherein the image field of the camera is divided into SAW-segment-imaging image field segments in such a way that after a definable interval of acquired images, a repetition of an identical allocation of imaged SAW segments in image field segments occurs; and
carrying out comparison operations in run phases, in which the image field segments of images that have an identical allocation of image field segments to imaged SAW segments are compared with one another and/or with a specific master.

2. The method as defined in claim 1, wherein during initializing the SAW is broken down into logical SAW segments, and the logical SAW segments are allocated to image field segments, in such a way that as the camera travels over the wafer an identical allocation of logical SAW segments to image field segments occurs at a definable travel interval and/or image interval.

3. The method as defined in claim 2, wherein the SAW is divided into logical SAW segments, preferably of identical size, and the logical SAW segments are allocated to the image field segments.

4. The method as defined in claim 2, wherein the logical SAW segments and the image field segments are each indexed, and there is allocated to the image field segments a combination of SAW segment index and image field segment index, on the basis of which a determination is made of the image field segments to be compared, those image field segments which have an identical combination of SAW segment index and image field segment index preferably being compared with one another.

5. The method as defined in claim 1, wherein a comparison of physically adjacent image field segments is performed.

6. The method as defined in claim 1, wherein offsets of a SAW are learned during initializing and are taken into account in determining the allocation.

7. The method as defined in claim 1, wherein at least one region that is invalid and that is blanked out upon comparison of the image field segments can be defined within a SAW and/or a SAW segment, in which context the validity can depend on the position of the SAW on a wafer.

8. The method as defined in claim 1, wherein a line camera or an area camera is used, to acquire a microscopic or macroscopic images.

9. The method as defined in claim 1, wherein a line camera is used, which can acquire microscopic or macroscopic images, and the wafer is illuminated with a continuous light source.

10. The method as defined in claim 1, wherein an area camera is used, which can acquire microscopic or macroscopic images.

11. The method as defined in claim 1, wherein a relative motion of the wafer with respect to the camera occurs, and is preferably continuous.

12. The method as defined in claim 11, wherein an image is acquired by way of a flash that is triggered, with the diaphragm open, as a function of the relative position of the wafer.

13. An apparatus for the analysis of surface images of at lest one wafer, wherein the at least one wafer has features that are generated using a SAW, the apparatus comprising:
a camera to acquire a plurality of images of the at least one wafer, wherein the camera defines an image field;
a memory region in which the plurality of images of the wafer, acquired with the camera, are storable;
means for initializing in a learning phase in which the image field of the camera is divided into SAW-segment-imaging image field segments in such a way that after a definable interval of acquired images, a repetition of an identical allocation of imaged SAW segments in image field segments occurs; and
a processing unit for carrying out comparison operations in such a way that in, the image field segments of images that have an identical allocation of image field segments to imaged SAW segments are compared with one another and/or with a specific model.

14. The apparatus as defined in claim 13, wherein the memory region is managed, by means of an array and/or a hash function, in such a way that the logical SAW segments and the image field segments are each indexed, and there is allocated to the image field segments a combination of SAW segment index and image field segment index, on the basis of which a determination is made of the image field segments to be compared, those image field segments which have an identical combination of SAW segment index and image field segment index preferably being compared with one another.

15. The apparatus as defined in claim 13, wherein a device of the processing unit compares only physically adjacent image field segments with one another on the basis of a metric.

16. The apparatus as defined in claim 13, wherein the means for initializing are configured to learn offsets of a SAW in the initialization phase and to account for upon determination of the allocation.

17. A software program for a computer, wherein the software program makes the computer to operate according to a method for analyzing at least one wafer which has a plurality features that were generated with a SAW, comprising the steps of:
moving a camera, having an image flied, over a wafer and thereby acquiring with its image field a plurality of images;
initializing in a learning phase the image field of the camera, wherein the image field of the camera is divided into SAW-segment-imaging image field segments in such a way that after a definable interval of acquired images, a repetition of an identical allocation of imaged SAW segments in image field segments occurs; and
carrying out comparison operations in run phases, in which the image field segments of images that have an identical allocation of image field segments to imaged SAW segments are compared with one another and/or with a specific master.

18. The software as defined in claim 17, wherein during initializing the SAW is broken down into logical SAW segments, and the logical SAW segments are allocated to image field segments, in such a way that as the camera travels over the wafer an identical allocation of logical SAW segments to image field segments occurs at a definable travel interval and/or image interval.

19. The software as defined in claim 18, wherein the SAW is divided into logical SAW segments, preferably of identical size, and the logical SAW segments are allocated to the image field segments.

20. The software as defined in claim 18, wherein the logical SAW segments and the image field segments are each indexed, and there is allocated to the image field segments a combination of SAW segment index and image field segment index, on the basis of which a determination is made of the image field segments to be compared, those image field segments which have an identical combination of SAW segment index and image field segment index preferably being compared with one another.

21. The software as defined in claim 17, wherein a comparison of physically adjacent image field segments is performed.

22. The software as defined in claim 17, wherein offsets of a SAW are learned during initializing and are taken into account in determining the allocation.

23. The software as defined in claim 17, wherein at least one region that is invalid and that is blanked out upon comparison of the image field segments can be defined within a SAW and/or a SAW segment, in which context the validity can depend on the position of the SAW on a wafer.

24. The software as defined in claim 17, wherein a line camera is used, which can acquire microscopic or macroscopic images, and the wafer is illuminated with a continuous light source.

25. The software as defined in claim 17, wherein an area camera is used, which can acquire microscopic or macroscopic images.

26. A data medium for a computer stores of a software program wherein the software program makes the computer to operate according to a method for analyzing at least one wafer which has a plurality features that were generated with a SAW, comprising the steps of:
moving a camera, having an image flied, over a wafer and thereby acquiring with its image field a plurality of images;
initializing in a learning phase the image field of the camera, wherein the image field of the camera is divided into SAW-segment-imaging image field segments in such a way that after a definable interval of acquired images, a repetition of an identical allocation of imaged SAW segments in image field segments occurs; and
carrying out comparison operations in run phases, in which the image field segments of images that have an identical allocation of image field segments to imaged SAW segments are compared with one another and/or with a specific master.
